(19) United States
(12) Patent Application Publication
(10) Pub. No.: US 2024/0071144 A1
(43) Pub. Date: Feb. 29, 2024

(54) MOTOR-DRIVEN TELESCOPIC INTELLIGENT AUXILIARY DEVICE FOR CARD-ISSUING MACHINE

(71) Applicant: Hoi Ki Vicky LAU, Hong Kong (HK)

(72) Inventor: Hoi Ki Vicky LAU, Hong Kong (HK)

(21) Appl. No.: 17/895,030

(22) Filed: Aug. 24, 2022

(51) Int. Cl. G07B 3/02; G07B 5/04

(52) U.S. Cl. CPC G07B 3/02; G07B 5/04

(57) ABSTRACT

A motor-driven telescopic intelligent auxiliary device for a card-issuing machine includes a button auxiliary device and card-issuing auxiliary device. The button auxiliary device includes a driving mechanism arranged on the card-issuing machine inside the back of the button and a take-up and pay-off mechanism arranged on the driving mechanism. The card-issuing auxiliary device includes a card-sending mechanism arranged on the card-issuing machine inside the back of the card outlet and a card acquiring mechanism installed on the card outlet outer wall. The motor-driven telescopic intelligent auxiliary device extends out the button auxiliary device for a certain distance, so that the user can easily press the card-acquiring button. A card acquiring mechanism is further used to clamp the card and put it into the card-sending box, and the card-issuing auxiliary device extends the card-sending box forward so that the driver may take the card more easily.

### FIELD OF THE INVENTION

The present invention relates to the field of card-issuing machines for issuing cards applicable to highway or parking lot toll collection systems, and more particularly to a motor-driven telescopic intelligent auxiliary device for a card-issuing machine.

### BACKGROUND OF THE INVENTION

With the rapid development in highways, there is growing difficulty in the allocation of card issuers due to the increased traffic flow. On one hand, there is a need for improving the quality of service by increasing the number of lanes and managing the service time. On the other hand, the costs on card issuers have risen drastically, and thus it is unlikely to greatly increase the number of card issuers. Nowadays the labor-intense card-issuing methods have been replaced with automatic card-issuing machines, which well achieves the goal of reducing the number of personnel but with increased efficiency. It has incomparable advantages over manual card-issuing as it can provide 24-7 services, but some limitations of the card-issuing machines should not be neglected.

The existing card-issuing machine requires the driver to self-press the button to pick up the card. This takes longer than manually delivering the card, and thus may result in the traffic jam due to the massive traffic flow and slow servers. On the other hand, since the card-issuing machine is installed with a certain distance from the roadside to avoid collision with the vehicle, the driver needs to stretch out his/her arm as far as possible to get the card. Sometimes, when the stop location of the vehicle is not close to the roadside, leaving the driver no choice but to unfasten the seat belt or even open the card door to get the card. The above problems increase the difficulty of acquiring the card, which brings drivers inconvenience and affects the user experience, and indirectly slows down the traffic flow.

China patent (No. CN201721036679.5) discloses a card-issuing robotic arm for an automatic card-issuing machine, which cooperates with the card-issuing robotic arm. The robotic arm includes a card clamping device provided on a side or the top of the card-issuing machine, and a telescopic arm and a telescopic driving mechanism connected to the card clamping device. The card-issuing robotic arm is characterized in that the telescopic arm and the telescopic driving mechanism can move vertically or horizontally at the card-sending outlet of the card-issuing machine, so that the card clamping device can achieve the result of obtaining prior to sending the card.

Despite the aforementioned automatic card-issuing machine has slightly improved the way of acquiring cards for drivers, it fails to solve the rooted problems. Drivers not only may feel difficult to get the card, but also feel difficult to press the card-acquiring button as the vehicle generally does not stop close enough to the machine, and therefore the driver has no choice but to get out of the car to reach the button. The above problem quite often causes traffic jam.

### SUMMARY OF THE INVENTION

Aiming at solving the deficiencies of the existing technology, an objective of the present invention is to provide a motor-driven telescopic intelligent auxiliary device for a card-issuing machine. The button of the machine may be extended out for a certain distance by the button auxiliary device, so that the user can more easily press the card-acquiring button. Further, the card acquiring mechanism of card-issuing auxiliary device is further utilized to clamp the card and put it into the card-sending box, and then the card-issuing auxiliary device extends the card-sending box forward so that the driver may get the card more easily.

To solve the aforementioned problem, the present invention provides technical solutions as follows.

A motor-driven telescopic intelligent auxiliary device for a card-issuing machine comprises a button auxiliary device and a card-issuing auxiliary device. The button auxiliary device comprises a driving mechanism and a take-up and pay-off mechanism. The driving mechanism is arranged on the back of a button inside the card-issuing machine, and the take-up and pay-off mechanism is arranged on the driving mechanism. The card-issuing auxiliary device comprises a card-sending mechanism and a card acquiring mechanism. The card-sending mechanism is arranged on the back of a card outlet inside the card-issuing machine, and the card acquiring mechanism is installed on the outer wall of the card outlet.

Further, the driving mechanism comprises a linear actuator installed horizontally inside the card-issuing machine, and the output end of the linear actuator extends towards the button and is provided with a fixing sleeve for fixing the button. The take-up and pay-off mechanism comprise a fixture, the fixture is connected to the outer wall of the rear end of the linear actuator, the top of the fixture is further provided with a fixing rod, a flat turbine spring is fixedly installed on the top of the fixing rod, and one end of the flat turbine spring is fixedly connected to the back of the button.

Further, the card-sending mechanism comprises an electric sliding table, card-sending rod, card-sending box and two gas springs. The electric sliding table is horizontally installed inside the card-issuing machine and located below the card outlet. A mounting stand is provided on a sliding block of the electric sliding table, and both of the gas springs are horizontally installed on the mounting stand.

Further, the card acquiring mechanism comprises a clamping assembly and two sets of telescopic assemblies arranged on respective sides of the card outlet. The sets of telescopic assemblies are structurally identical to each other, and each of the sets of telescopic assemblies comprises clamping blocks, limiting plates, first rod and second rod. The clamping block is arranged outside the card-issuing machine and at the card outlet.

Further, the top of the first rod and the top of second rod are connected to the bottom of the clamping block. The bottom of the first rod and the bottom of the second rod horizontally pass through the outer wall of the card-issuing machine. The first rod and the second rod are slidingly fitted on the outer wall of the card-issuing machine. Each of the front end of the first rod and the front end of the second rod is provided with a limiting ring located outside the card-issuing machine. The bottom of the first rod and the bottom of the second rod are connected to the limiting plate.

The clamping assembly comprises a miniature electric telescopic rod, output rod and clamping plate. The miniature electric telescopic rod is installed inside the clamping block, and the output end of the miniature electric telescopic rod extends towards the other clamping block. One end of the output rod is connected to the output end of the miniature electric telescopic rod. The other end of the output rod passes through the outer wall of the clamping block. The output rod is slidingly fitted on the clamping block. The clamping plate is fixedly installed on the other end of the output rod.

### Advantageous Effects

The motor-driven telescopic intelligent auxiliary device for a card-issuing machine provided by the present invention extends the button, by the button auxiliary device, out for a certain distance, so that the user may more easily press the card-acquiring button. Moreover, the card acquiring mechanism of the card-issuing auxiliary device further clamps the card and put it into the card-sending box, and then the card-issuing auxiliary device extends the card-sending box forward for the driver to more easily take the card. Furthermore, in order to prevent the power line of the button from being damaged, a take-up and pay-off mechanism structure is also set up to ensure the safety of the power line.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating the front view of a motor-driven telescopic intelligent auxiliary device for a card-issuing machine according to an embodiment of the present invention;

FIG. 2 is a diagram illustrating the cross-sectional view, taken along the line A-A in FIG. 1;

FIG. 3 is a diagram illustrating the three-dimensional structure of a button auxiliary device of the motor-driven telescopic intelligent auxiliary device for the card-issuing machine according to an embodiment of the present invention;

FIG. 4 is a diagram illustrating the three-dimensional structure of a take-up and pay-off mechanism of the motor-driven telescopic intelligent auxiliary device for the card-issuing machine according to an embodiment of the present invention;

FIG. 5 is a diagram illustrating the three-dimensional structure of a card-issuing auxiliary device of the present invention the motor-driven telescopic intelligent auxiliary device for the card-issuing machine according to an embodiment of the present invention;

FIG. 6 is a diagram illustrating the three-dimensional structure of a card-issuing auxiliary device of the motor-driven telescopic intelligent auxiliary device for the card-issuing machine according to another embodiment of the present invention; and

FIG. 7 is a diagram illustrating the three-dimensional structure of a card-sending mechanism of the motor-driven telescopic intelligent auxiliary device for the card-issuing machine according to another embodiment of the present invention.

### DETAILED DESCRIPTION OF PREFERRED EMBODIMENTS

Specific embodiments of the present invention will be described in further detail accompanying the drawings and examples as follows.

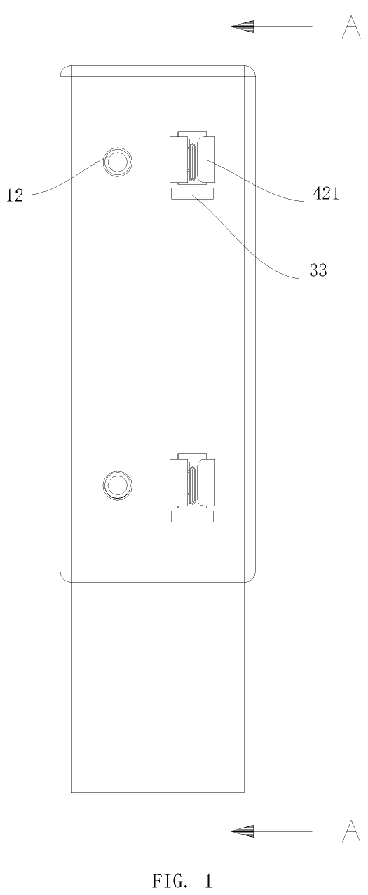

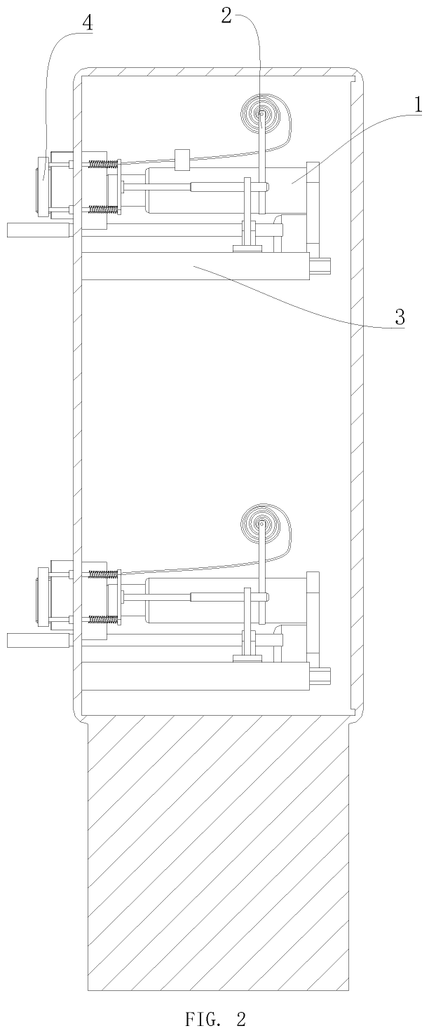

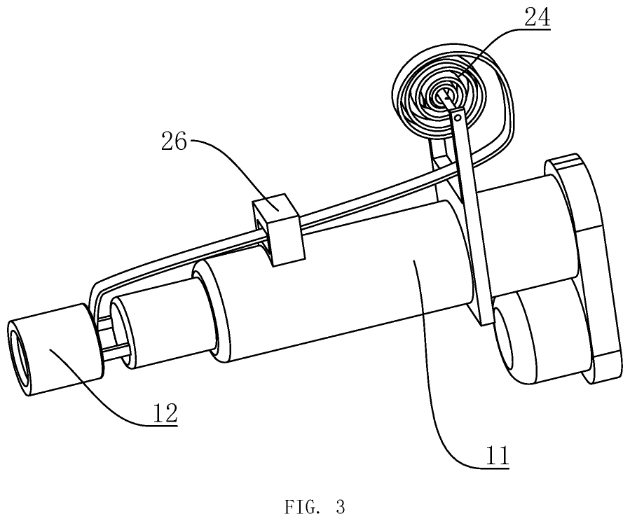

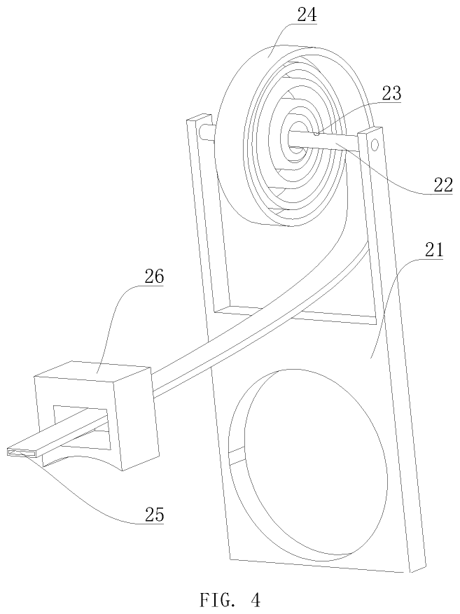

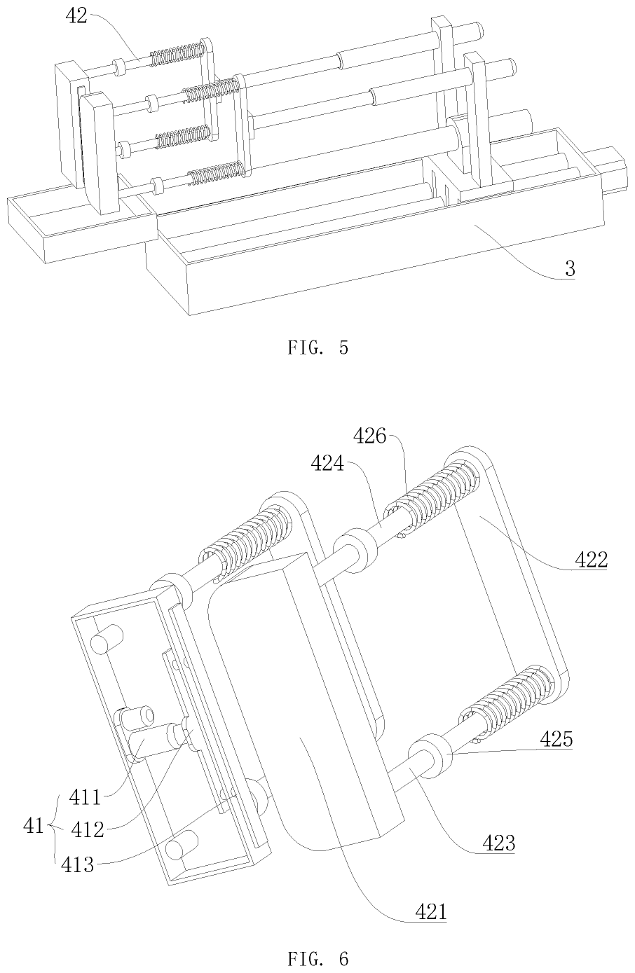

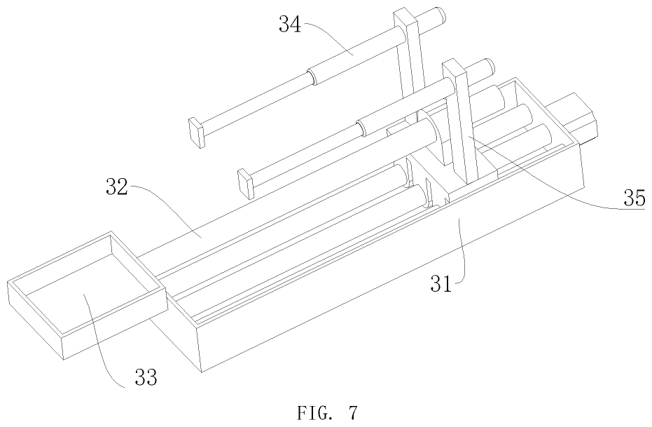

FIG. 1 to FIG. 7 illustrate a motor-driven telescopic intelligent auxiliary device for a card-issuing machine, which comprises a button auxiliary device and a card-issuing auxiliary device. The button auxiliary device comprises a driving mechanism 1 arranged on the back of the button inside the card-issuing machine, and a take-up and pay-off mechanism 2 arranged on the driving mechanism 1. The card-issuing auxiliary device comprises a card-sending mechanism 3 arranged on the back of the card outlet inside the card-issuing machine, and a card acquiring mechanism 4 installed on the outer wall of the card outlet.

The driving mechanism 1 comprises a linear actuator 11 horizontally installed inside the card-issuing machine. The output end of the linear actuator 11 extends towards the button. The output end of the linear actuator 11 is provided with a fixing sleeve 12 for fixing the button. The button is arranged inside the fixing sleeve 12, and a first through hole is provided on the outer wall of the card-issuing machine for the fixing sleeve 12 to pass through.

When a vehicle is detected next to the card-issuing machine, the linear actuator 11 pushes the fixing sleeve 12 forward. After the button arranged inside the fixing sleeve 12 is extended out, it is more convenient for the driver to press the button. The first through hole is provided for the output end of the linear actuator 11 and the fixing sleeve 12 to pass through.

The take-up and pay-off mechanism 2 comprises a fixture 21. The fixture 21 is fixedly connected to the outer wall at the rear end of the linear actuator 11. The fixing rod 22 is horizontally arranged at the top of the fixture 21. A flat turbine spring 24 is fixedly installed around the top of the fixing rod 22, and one end of the flat turbine spring 24 is fixedly connected to the back of the button. A second through hole 25 is provided inside the flat turbine spring 24 for button lines to pass through. The fixing rod 22 is provided with a third through hole 23 for button lines to pass through, and the middle part of the outer wall of the linear actuator 11 is also provided with a spring limiting member 26.

When the linear actuator 11 pushes the button out, the power and signal lines of the button also need to be stretched along, and therefore there is a need for using the flat turbine spring 24. The second through hole 25 is provided in the flat turbine spring 24, and the signal and power lines are inserted into the second through hole 25. When the flat turbine spring 24 is straightened or rolled up, the signal and power lines are also straightened or rolled up accordingly. A third through hole 23 is provided on the fixing rod 22 for the power and signal lines to pass through, in order to connect to the controller.

The card-sending mechanism 3 comprises an electric sliding table 31, card-sending rod 32, card-sending box 33 and two gas springs 34. The electric sliding table 31 is horizontally installed inside the card-issuing machine and below the card outlet. The sliding block of the electric sliding table 31 is provided with a mounting stand 35, and the two gas springs 34 are horizontally installed on the mounting stand 35. The output end of each of the gas springs 34 extends towards a limiting plate 422. The rear end of the card-sending rod 32 is fixedly connected to the mounting stand 35. The top of the card-sending rod 32 passes through the outer wall of the card-issuing machine and is located below the card outlet. The card-sending box 33 is fixedly installed on the top of the card-sending rod 32.

The card acquiring mechanism 4 comprises a clamping assembly 41 and two sets of telescopic assemblies 42 arranged on respective sides of the card outlet. The two sets of telescopic assemblies 42 are structurally identical to each other, and each comprises a clamping block 421, limiting plate 422, first rod 423 and second rod 424. The clamping block 421 is arranged outside the card-issuing machine and located at the card outlet. The top of the first rod 423 and the top of the second rod 424 are connected to the bottom of the clamping block 421. The bottom of the first rod 423 and the bottom of the second rod 424 horizontally pass through the outer wall of the card-issuing machine, and the first rod 423 and second rod 424 are slidingly fitted on the outer wall of the card-issuing machine. The front end of the first rod 423 and the front end of the second rod 424 are both provided with a limiting ring 425 located outside the card-issuing machine. The bottom of the first rod 423 and the bottom of the second rod 424 are fixedly connected to the limiting plate 422. A return spring 426 is provided on the outer wall of each of the first rod 423 and the second rod 424 at the part located inside the card-issuing machine. The return spring 426 is located between the limiting ring 425 and the limiting plate 422. The clamping assembly 41 is installed on one of the clamping blocks 421.

The clamping assembly 41 comprises a miniature electric telescopic rod 411, output rod 412 and clamping plate 413. The miniature electric telescopic rod 411 is installed inside the clamping block 421, and the output end of the miniature electric telescopic rod 411 extends towards the other clamping block 421. One end of the output rod 412 is connected to the output end of the miniature electric telescopic rod 411, and the other end of the output rod 412 passes through the outer wall of the clamping block 421. The output rod 412 is slidingly fitted on the clamping block 421, and the clamping plate 413 is fixedly installed on the other end of the output rod 412.

After the driver presses the button, the card outlet will issue a card, and part of the card will be extended out of the card outlet. The miniature electric telescopic rod 411 pushes the output rod 412, and the clamping plate 413 on the output rod 412 pushes the card to facing towards the other clamping block 421 and cooperates with another clamping block 421 to clamp the card. Meanwhile, the electric sliding table 31 drives the sliding block to make the output end of the gas springs 34 face the limiting plate 422, so that the telescopic assemblies 42 are moved in parallel. After the entire card is extended out of the card outlet, the clamping assembly 41 releases the card so that the card naturally falls into the card-sending box 33. Meanwhile, the electric sliding table 31 mechanically drives the sliding block to make the card-sending box 33 move forward so that the driver may reach the card more easily. One thing to be noted is that when the electric sliding table 31 mechanically drives the sliding block to continue moving forward, the telescopic assembly 42 will not be damaged from abutting, as the telescopic assembly 42 is abutted by the gas spring 34. When the limiting plate 422 abuts the return spring 426 so that the sliding block cannot move forward, the output shaft of the gas springs 34 will retract when under the force. After the all steps of sending the card are completed, the return spring 426 will restore and reset the telescopic assembly 42.

The above-mentioned are only the preferred embodiments of the present invention, and are not meant to limit the technical scope of the present invention. Therefore, any equivalent modifications and changes made based on the spirit of the above embodiments of the present invention shall fall within the claimed scope of the present invention.

What is claimed is:

1. A motor-driven telescopic intelligent auxiliary device for a card-issuing machine, comprising: a button auxiliary device and a card-issuing auxiliary device, wherein:
the button auxiliary device comprises a driving mechanism arranged on the back of a button inside the card-issuing machine and a take-up and pay-off mechanism arranged on the driving mechanism, and the card-issuing auxiliary device comprises a card-sending mechanism arranged on the back of a card outlet inside the card-issuing machine and a card acquiring mechanism installed on the outer wall of the card outlet;
the driving mechanism comprises a linear actuator installed horizontally inside the card-issuing machine, an output end of the linear actuator extends towards the button and is provided with a fixing sleeve for fixing the button, the take-up and pay-off mechanism comprises a fixture, the fixture is connected to the outer wall of the rear end of the linear actuator, a top of the fixture is further provided with a fixing rod, a flat turbine spring is fixedly installed on the top of the fixing rod, and one end of the flat turbine spring is fixedly connected to the back of the button;
the card-sending mechanism comprises an electric sliding table, a card-sending rod, a card-sending box and two gas springs, the electric sliding table is horizontally installed inside the card-issuing machine and located below the card outlet, a mounting stand is provided on a sliding block of the electric sliding table, and both of the gas springs are horizontally installed on the mounting stand;
the card acquiring mechanism comprises a clamping assembly and two sets of telescopic assemblies arranged on respective sides of the card outlet, the two sets of telescopic assemblies are structurally identical to each other, each of the two sets of telescopic assemblies comprises a clamping block, a limiting plate, a first rod and a second rod, the clamping block is arranged outside the card-issuing machine and at the card outlet, the top of the first rod and the top of second rod are connected to the bottom of the clamping block, the bottom of the first rod and the bottom of the second rod horizontally pass through the outer wall of the card-issuing machine, the first rod and the second rod are slidingly fitted on the outer wall of the card-issuing machine, each of the front end of the first rod and the front end of the second rod is provided with a limiting ring located outside the card-issuing machine, and the bottom of the first rod and the bottom of the second rod are connected to the limiting plate; and
the clamping assembly comprises a miniature electric telescopic rod, an output rod and a clamping plate, the miniature electric telescopic rod is installed inside the clamping block and the output end of the miniature electric telescopic rod extends towards the other clamping block, one end of the output rod is connected to the output end of the miniature electric telescopic rod, the other end of the output rod passes through the outer wall of the clamping block, the output rod is slidingly fitted on the clamping block, and the clamping plate is fixedly installed on the other end of the output rod.

2. The motor-driven telescopic intelligent auxiliary device for the card-issuing machine according to claim 1, wherein a first through hole is further provided on the outer wall of the card-issuing machine for the fixing sleeve to pass through.

3. The motor-driven telescopic intelligent auxiliary device for the card-issuing machine according to claim 1, wherein a second through hole is provided inside the flat turbine spring for a button line to pass through.

4. The motor-driven telescopic intelligent auxiliary device for the card-issuing machine according to claim 1, wherein a third through hole is provided on the fixing rod for the button line to pass through.

5. The motor-driven telescopic intelligent auxiliary device for the card-issuing machine according to claim 1, wherein a middle part of the outer wall of the linear actuator is further provided with a spring limiting member.

6. The motor-driven telescopic intelligent auxiliary device for the card-issuing machine according to claim 1, wherein each of the outer walls of the first rod and the second rod is sleeved with a return spring inside the card-issuing machine, and the return spring is located between the limiting ring and the limiting plate.

7. The motor-driven telescopic intelligent auxiliary device for the card-issuing machine according to claim 1, wherein the clamping assembly is installed on one of the clamping blocks.

8. The motor-driven telescopic intelligent auxiliary device for the card-issuing machine according to claim 1, wherein the output end of each of the gas springs extends towards the respective limiting plate.

9. The motor-driven telescopic intelligent auxiliary device for the card-issuing machine according to claim 1, wherein the rear end of the card-sending rod is fixedly connected to a mounting stand, the top of the card-sending rod passes through the outer wall of the card-issuing machine and is located below the card outlet, and the card-sending box is fixedly installed on the top of the card-sending rod.
